(19) United States
(12) Patent Application Publication
(10) Pub. No.: US 2026/0269941 A1
(43) Pub. Date: Sep. 10, 2026

(54) INTER-SATELLITE LINKS WITH IMPROVED RESILIENCE

(71) Applicant: Hughes Network Systems, LLC, Germantown, MD (US)

(72) Inventor: Rohit Iyer Seshadri, Germantown, MD (US)

(21) Appl. No.: 19/075,723

(22) Filed: Mar. 10, 2025

(51) Int. Cl. H04B 10/118

(52) U.S. Cl. CPC H04B 10/118

(57) ABSTRACT

Methods, systems, and apparatus, including computer programs encoded on computer-storage media, for inter-satellite links with improved resilience. In some implementations, a satellite has a communication terminal configured to establish an inter-satellite data transfer link with a second satellite. The communication terminal includes multiple optical transmit apertures and is configured to use the multiple optical transmit apertures together to establish the inter-satellite data transfer link with the second satellite. The optical transmit apertures of the multiple optical transmitters are each positionable. The communication terminal is configured to cause the multiple optical transmit apertures to perform synchronized transmission of a same data stream. The communication terminal comprises a controller that is configured to adjust positions of the optical transmit apertures based on indications of received signal quality from the second satellite.

### BACKGROUND

The present specification relates to inter-satellite communication links.

Groups of multiple satellites can be used to relay data and provide network access. For example, satellites in low-earth orbit (LEO) can operate together to provide Internet access or other network access. These satellites often communicate with each other using inter-satellite communication links.

### SUMMARY

In some implementations, a satellite constellation provides inter-satellite data transfer links (ISLs) with various features that can improve resilience and reliability. ISLs often include spatially-directed beams from one satellite to another, such as with a laser communication link between satellites (e.g., free-space optical communication). In general, jitter and other error in the pointing of the satellites' transmitters and receivers can diminish the quality of the link or break the link entirely. To improve reliability, techniques such as spatial diversity and repetition coding improve the resilience of the laser communication link to strong pointing jitters. This can provide performance advantages of reduced bit error rate and increased transmit power efficiency.

Constellations of satellites can be used to provide network access, including broadband Internet service. For example, a constellation of several hundred or several thousand low-earth orbit (LEO) satellites can operate together to provide consistent network access over a wide coverage area. Despite their potential for low-latency connectivity, LEO satellite constellations present some unique challenges due to their lower altitudes (e.g., 500 km-1200 km), such as limited field-of-view relative to geostationary (GEO) satellites.

The limited temporal visibility and spatial visibility of LEO satellites poses a challenge in deploying adequate number terrestrial gateways at suitable locations. In other words, because of the limited field-of-view and high speed of LEO satellites, a LEO satellite may not always be in a position to communicate with any terrestrial gateway. ISLs allow satellites that are not currently in direct view of a terrestrial gateway to relay their traffic via neighboring satellites, which helps achieve widespread and even global connectivity. ISLs utilizing the free space optical band (FSO) are particularly attractive due to (1) large (e.g., about 4 THz) unlicensed spectrum and data rates of several gigabits (Gbps), (2) very narrow beams, which results in less interference and allow for lower transmitted power, and (3) smaller and lighter devices compared to other radiofrequency equipment.

Despite these advantages, optical ISLs are subject to performance degradation caused by pointing errors due to their very narrow beams, the large distances involved (e.g., >2000 km), the speed of the satellites, and the frequent vibrations experienced by the satellite bus (e.g., main body or structure of the satellite). Even after an optical link between two satellites is established (e.g., acquisition) and a tracking loop activated, the link is still subject to residual pointing errors due to factors, such as errors in the tracking loop and point-ahead mechanism and due to platform vibrations. The residual pointing errors known as pointing jitters are generally insignificant for radiofrequency links but can severely degrade error rate performance and power requirement in optical links.

As discussed below, the reliability of optical signaling in the presence of strong pointing jitters can be improved using spatial diversity and repetition coding. Spatial diversity can be achieved using multiple transmitters for a single ISL, such as transmitting separately from two or more different optical transmit apertures that are spaced apart. Using multiple transmitters increases the likelihood that a reliable link is achieved and maintained even when strong jitter is present. Repetition coding can be carried out by using the multiple transmitters to concurrently transmit the same data stream, either to a single optical receive aperture or to separate optical receive apertures. Together, spatial diversity and repetition coding can improve the resilience of laser communication links to strong pointing jitters, resulting in lower bit error rates and lower transmit power required.

The techniques discussed herein can thus improve power efficiency and error rate performance of an optical ISL, especially in the presence of strong residual pointing error. Acquisition, tracking, and pointing is often challenging for ISLs. Even when a link is acquired, and when closed-loop tracking is performed, the link performance is sensitive to random angular deviations from line-of-sight on the order of a few micro-radians. These deviations cause degradations in the bit error rate, result in an increase in the transmission power required, and/or entail a reduction in the data rate. The innovations detailed in this report will help improve the bit error rate performance, mitigate the power penalty, and avoid reduction in ISL data rate.

In one general aspect, a satellite comprises: a communication terminal configured to establish an inter-satellite data transfer link with a second satellite, wherein the communication terminal comprises multiple optical transmit apertures and is configured to use the multiple optical transmit apertures together to establish the inter-satellite data transfer link with the second satellite, wherein each of the optical transmit apertures of the multiple optical transmitters are each positionable; wherein the communication terminal is configured to cause the multiple optical transmitters to perform synchronized transmission of a same data stream; and wherein the communication terminal comprises a controller that is configured to adjust positions of the optical transmit apertures based on indications of received signal quality from the second satellite.

In some implementations, the communication terminal of the satellite is configured to separately position the optical transmit apertures.

In some implementations, the communication terminal of the satellite is configured to adjust a position of the optical transmit apertures to selectively transmit to (i) a single receive aperture of the second satellite or (ii) multiple receive apertures of the second satellite.

In some implementations, the communication terminal of the satellite is configured to operate in multiple modes, including (i) a first mode in which the multiple optical transmit apertures are directed to a same, single receive aperture of the second satellite, and (ii) a second mode in which the multiple optical transmit apertures are directed to separate receiver apertures of the second satellite.

In some implementations, the controller of the communication terminal is configured to position the optical transmit apertures to (i) align the optical transmit apertures with one or more optical receive apertures of the second satellite and (ii) maintain alignment of the optical transmit apertures with one or more optical receive apertures of the second satellite over time.

In some implementations, the satellite includes a separate optical modulator for each of the optical transmit apertures; and the communication terminal is configured to receive an electrical information signal and to provide the received electrical information signal to the optical modulators, such that each of the optical modulators separately converts the electrical information signal to optical signals.

In some implementations, the satellite includes a separate optical booster amplifier and telescope for each of the optical transmit apertures, and wherein each of the optical modulators is coupled to its corresponding optical booster amplifier and telescope through fiber optics.

In some implementations, the communication terminal is configured to direct the positions of the optical transmit apertures based on open loop feedback or closed loop feedback.

In some implementations, the satellite and the second satellite are low-earth orbit (LEO) satellites.

In some implementations, the communication terminal is configured to establish bi-directional communication over the inter-satellite data transfer link.

In some implementations, the inter-satellite data transfer link is a laser communication link.

In some implementations, the communication terminal is configured to transmit on the inter-satellite data transfer link using an amplitude modulation keying.

In some implementations, the communication terminal is configured to transmit on the inter-satellite data transfer link using on-off keying (OOK).

In some implementations, the communication terminal is configured to transmit on the inter-satellite data transfer link using non-coherent communication that is modulated in amplitude without carrying information in the phase of the signals transmitted.

In some implementations, the optical transmit apertures are spaced apart by a predetermined amount.

In some implementations, the controller of the communication terminal is configured to (i) use open loop feedback to initiate a link with the second satellite and (ii) transition to closed-loop tracking to maintain communication.

In some implementations, the controller has separate control loops to position the optical transmit apertures separately.

In some implementations, the controller is configured to use a single control loop to adjust the positions of the optical transmit apertures together.

In some implementations, the communication terminal comprises a receiver configured to receive signals over the inter-satellite data transfer link, wherein the receiver includes a telescope providing an optical receive aperture, an optical preamplifier, a polarization filter, an optical bandpass filter, and a photodetector.

In some implementations, the receiver comprises a low noise amplifier configured to receive signals detected using the photodetector, a low-pass filter configured to filter signals from the low-noise amplifier, and a decision module configured to determine bits based on signals output from the low-pass filter.

In some implementations, the photodetector is a P-type, Intrinsic, N-type (PIN) photodiode.

In some implementations, the satellite comprises multiple receivers each having a separate receive aperture, and wherein the satellite is configured to use signals received concurrently through the multiple receivers together to receive data over an inter-satellite data transfer link with another satellite.

In some implementations, the satellite comprises multiple receivers and multiple transmitters and is configured to concurrently maintain inter-satellite data transfer links with multiple other satellites.

In some implementations, the satellite comprises multiple communication terminals to concurrently maintain inter-satellite data transfer links with multiple other satellites, wherein each of the communication terminals comprises multiple transmitters or multiple receivers.

In another general aspect, a method performed by one or more processors includes: initiating, by a first satellite, a inter-satellite data transfer link with a second satellite, wherein the first satellite comprises multiple optical transmit apertures configured to be used concurrently to provide the inter-satellite data transfer link; positioning, by the first satellite, the optical transmit apertures with respect to the second satellite; performing, by the first satellite, synchronized transmission of a same data stream using each of the multiple optical transmit apertures; and adjusting, by the first satellite, positions of the optical transmit apertures based on indications of received signal quality from the second satellite.

In some implementations, positioning the optical transmit apertures comprises separately positioning the optical transmit apertures.

In some implementations, the first satellite is configured to adjust a position of the optical transmit apertures to selectively transmit (i) from multiple optical transmit apertures to a same single receive aperture of the second satellite or (ii) from multiple optical transmit apertures to different corresponding receive apertures of the second satellite.

In some implementations, the first satellite is configured to operate in multiple modes, including (i) a first mode in which the multiple optical transmit apertures are directed to a same, single receive aperture of the second satellite, and (ii) a second mode in which the multiple optical transmit apertures are directed to separate receiver apertures of the second satellite.

In some implementations, the method includes: aligning the optical transmit apertures with one or more optical receive apertures of the second satellite; and adjusting positions of the optical transmit apertures to maintain alignment of the optical transmit apertures with one or more optical receive apertures of the second satellite over time.

In some implementations, the first satellite comprises a separate optical modulator for each of the optical transmit apertures. The method includes: receiving an electrical information signal; and providing the received electrical information signal to the optical modulators, such that each of the optical modulators separately converts the electrical information signal to optical signals.

In some implementations, the first satellite includes an optical booster amplifier and telescope for each of the optical transmit apertures, and wherein each of the optical modulators is coupled to its corresponding optical booster amplifier and telescope through fiber optics.

Other embodiments of these aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a satellite communication network including inter-satellite data transfer links among satellites.

FIG. 2 is a diagram showing an example of techniques for acquisition, pointing, and tracking between optical terminals of satellites in space.

FIG. 3 is a diagram showing an example of a transmitter for a free-space optical terminal for a satellite.

FIG. 4 is a diagram showing an example of a receiver for a free-space optical terminal for a satellite.

FIG. 5 is a diagram showing an example of free-space optical beam footprint and normalized intensity.

FIGS. 6A-6B are diagrams showing examples of transmitted beam footprints and position of a receiver's aperture.

FIGS. 7A-7B are graphs showing probability density functions of random radial displacement due to pointing jitters.

FIGS. 8A-8B are graphs showing bit error rates of an optical inter-satellite link using intensity modulation with direct detection, with and without pointing errors.

FIG. 9A is a graph showing a bit error rate based on optimizing beam divergence angle or transmitter aperture diameter.

FIG. 9B is a graph showing an outage probability measure based on optimizing beam divergence angle or transmitter aperture diameter.

FIG. 10 is a diagram of an example of a transmitter that employs spatial diversity with repetition coding to mitigate the effects of pointing jitter.

FIG. 11 is a diagram of the transmitter of FIG. 10, positioned in alignment with a receiver.

FIG. 12 is a graph showing bit error rates for different conditions, including a condition in which two transmitters are aligned with a single receiver, which shows improvement resulting from spatial diversity with repetition coding.

FIG. 13 is a diagram showing an example depicting use of spatial diversity when two transmitters are not jointly aligned with the single receiver's boresight.

FIG. 14 is a graph showing bit error rates for different conditions, including a condition in which two transmitters are not jointly aligned with a single receiver, which shows improved performance resulting from spatial diversity with repetition coding even though the two transmitters are not ideally aligned with the receiver and are under strong jitters.

FIG. 15 is a diagram showing an example depicting the use of spatial diversity with repetition coding, using two transmitters aligned to two optical apertures at the receiving satellite.

FIG. 16 is a graph showing bit error rates for different conditions, including a condition in which two transmitters are aligned to separate optical apertures of a receiving satellite, which shows increased resilience to strong pointing errors and also an additional power gain due the use of two receiver apertures.

Like reference numbers and designations in the various drawings indicate like elements.

### DETAILED DESCRIPTION

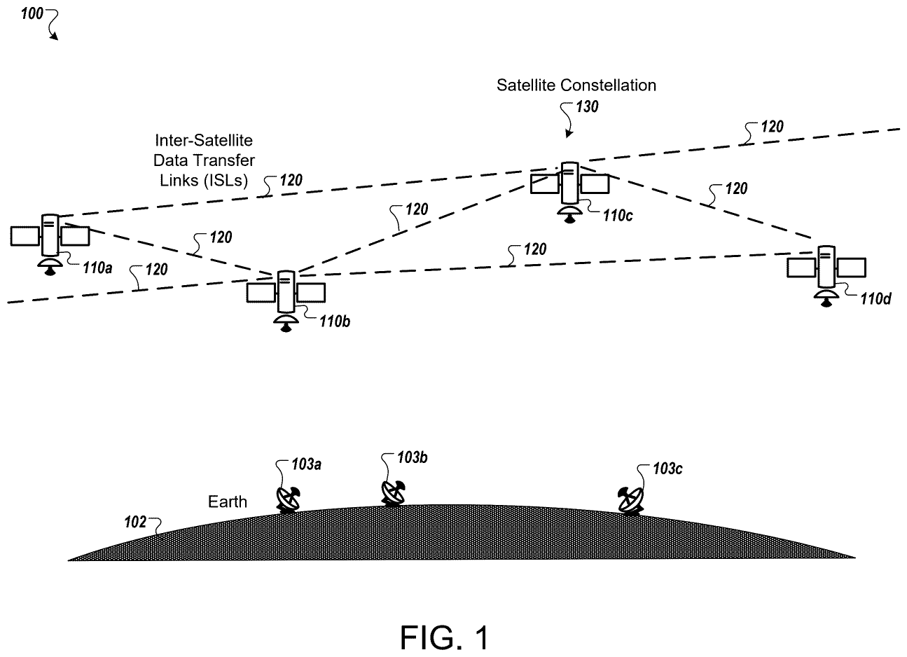

FIG. 1 is a diagram showing an example of a system 100 that includes a satellite communication network including inter-satellite data transfer links 120 among satellites 110. In the example, a satellite constellation 130 includes various satellites 110 (e.g., 110a-110d shown) that communicate with each other over the inter-satellite data transfer links (ISLs) 120. The satellites 110 in the satellite constellation 130 communicate ground stations, such as terrestrial gateways 103a-103c on the earth 102.

Each ISL 120 represents a free-space optical communication link, e.g., a laser communication link, between a pair of satellites 110. Due to the motion of the satellites 110, different satellites 110 enter and exit communication with the terrestrial gateways 103a-103c over time. At some portions of its trajectory, a satellite 110a may not have any of the terrestrial gateways 103a-103c in its field of view. In this case, the satellite 110a can relay data through one or more to other satellites 110 to send data to or receive data from a network. The satellites 110 may also exchange data over the ISLs 120 to create network paths between different pairs of gateways 103a-103c or for other reasons.

Over time, movement of the satellites 110 changes their relative positions, and so the pointing of transmitters and receivers is adjusted to maintain the ISLs 120 while the positions permit line of sight communication. Often, feedback loops are used to adjust positioning of transmitters and receivers to maintain the ISLs 120 once established. Even with the control of the feedback loops, vibration of the satellites 110 can introduce jitter that causes small frequent shifts in the positioning of the transmitters and receivers. Over long distances, the effect of even small changes is magnified so that jitter that creates even small changes in angular position can result in significant misalignment of the transmitters and receivers used in the ISLs 120. As discussed further below, the satellites 110 can use spatial diversity (e.g., multiple transmitters per ISL 120) and repetition coding (e.g., concurrent transmission of the same data through multiple transmitters used for the same ISL 120) io mitigate these pointing jitters and maintain stable ISLs 120, as well as improve data rates and improve power efficiency.

As the satellites 110 move, the set of ISLs 120 that remain can changes frequently over time, as different pairs of satellites 110 enter and exit the line-of-sight positioning that allows communication. New ISLs 120 are established as pairs of satellites 110 enter each others' field of view, and ISLs 120 are terminated as pairs of satellites 110 are no longer in each others' field of view.

The diffraction experienced by free-space optical beams is several orders-of-magnitude smaller than RF beams, resulting in a much smaller or tighter beam spot. This is beneficial to reduce interference and to maximize the amount of power delivered from transmitter to receiver. Nevertheless, it is also important to establish and maintain a good line-of-sight alignment between the space laser communication terminals (LCTs) of the satellites 110 that establish an ISL 120. The process of establishing a bi-directional communication link (e.g., ISL 120) typically begins with open loop acquisition. After acquisition, a closed loop tracking sub-system aims to maintain accurate line-of-sight (pointing and tracking) during data transfer between the communication subsystems.

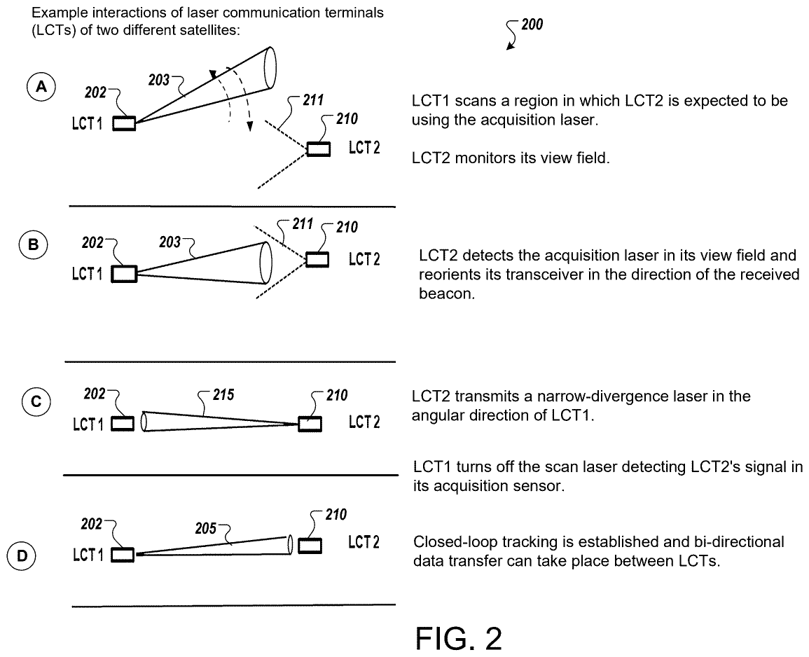

FIG. 2 is a diagram showing an example 200 of techniques for acquisition, pointing, and tracking between optical terminals of satellites 110 (e.g., LEO satellites) in space. The example shows interactions of laser communication terminals (LCTs) of two different satellites 110 and the actions performed as the two satellites 110 establish and maintain an ISL 120. The example shows four stages, labeled (A) through (D).

In stage (A), LCT 1 202 of a first satellite 110 uses an acquisition laser 203 to scan a region in which a second satellite 110 with a LCT 2 210 is expected to be. The LCT 1 202 scans the acquisition laser 203 back and forth while the LCT 2 210 monitors the view field 211 of its receiver. The two satellites 110 can store, or receive from gateways 103a-103c, position data or trajectory data indicating when and where nearby satellites are likely to be, so they can orient their transmitters and receivers in the appropriate directions at the appropriate times when line-of-sight communication becomes available.

In stage (B), LCT 2 210 detects the acquisition laser 203 in its view field 211 and, in response, reorients its transceiver in the direction of the received beacon signal from the LCT 1 202.

In stage (C), LCT 2 210 transmits a narrow-divergence laser 215 (e.g., narrower divergence than the acquisition laser 203) in the angular direction of LCT 1 202. LCT 1 202 turns off the scan laser 203 in response to detecting LCT 2's signal in the acquisition sensor of the LCT 1 202.

In stage (D), closed-loop tracking is established and bi-directional data transfer can take place between LCTs 202, 210 over the recently established ISL 120. As the satellites 110 continue to move, the closed-loop tracking is used to incrementally adjust the positions of the transmitters and receivers to maintain the ISL 120 until line of sight communication is no longer feasible.

The closed loop tracking and pointing mechanism is subject to noise from various internal and external sources, such as residual gimbal jitter, detector noise equivalent angle, solar array drive jitter, gimbal rate control jitter, satellite momentum wheel jitter, gimbal position control jitter, uncompensated jitter from optical sensor scan mirror, and more, all of which can cause residual pointing errors during and after acquisition. The conventional approach to mitigate the pointing jitter is by improving the optical-electrical components that make up the tracking-pointing sub-system of the LCT. However, this often involves large increases in the cost, weight, and/or power consumption of the components, and in many cases improving the precision or sensitivity of the components is not feasible. In addition to or instead of this approach, application of spatial diversity and repetition coding addresses the problem directly in the communication sub-system to provide improved reliability and efficiency.

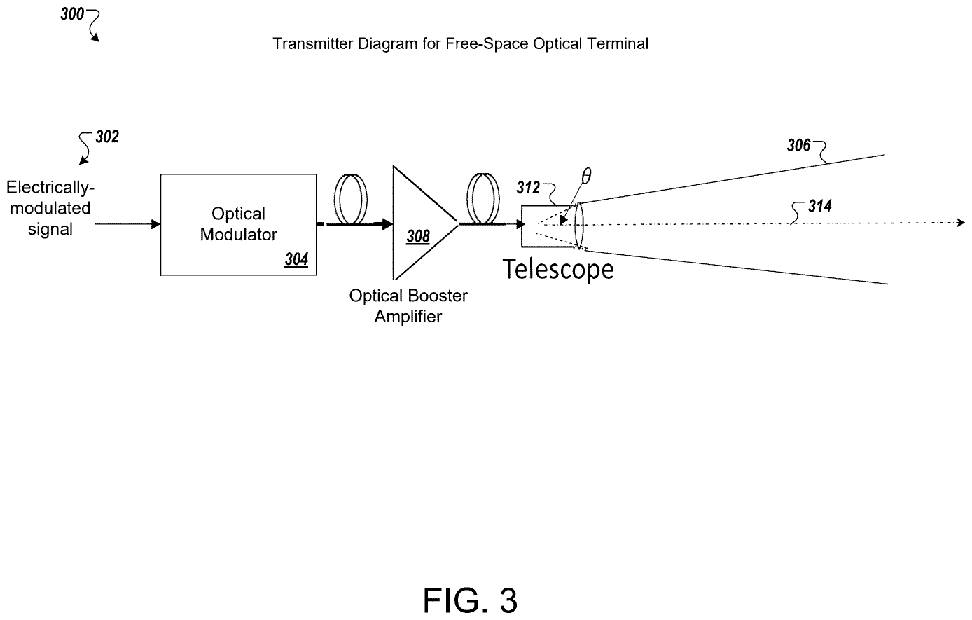

FIG. 3 is a diagram showing an example of a transmitter 300 for a free-space optical terminal (e.g., LCT) of a satellite 110. In general, a satellite 110 has a communication subsystem that includes at least one LCT, which typically includes an optical transmitter and an optical receiver. A satellite 110 can include multiple transmitters and/or receivers, and may include multiple LCTs. The example of FIG. 3 shows an example of a transmitter portion of a LCT that is configured to employ on-off keying (OOK) modulation and an optical booster amplifier 308.

The transmitter 300 receives an electrically modulated signal 302 that provides the information to be transmitted over an ISL 120. The transmitter 300 has an optical modulator 304 that performs electrical-to-optical conversion using a laser in the optical modulator 304. In this example, OOK is used for the modulation so that periods of the laser being on and off represent different bit values, for example, a bit “1” corresponds to an optical signal with power P and bit “0” corresponds to an optical signal with power 0 (e.g., laser off). The modulated optical signal from the optical modulator 304 is transmitted through optical fiber to a booster amplifier 308, and the amplified signal is transmitted to the transmission channel (e.g., space) using transmission optics comprising of lenses and/or mirrors in a telescope 312. The output signal proceeds along an axis 314, and the beam diverges as it travels so the size of the beam spot 306 increases in size the farther it travels from the transmitter 300 (which is shown in an exaggerated way in the figure).

The optical signal output by the telescope 312, along with background celestial radiation and spurious signals from the booster amplifier 308, will be incident on the receiver's telescope when the LCTs of two satellites are in alignment. The optical wavelength of the signal can be in the infrared spectral band, such as in the C-band (e.g., 1530-1565 nm). The particular example illustrated can have a wavelength of, for example, about 1550 nm.

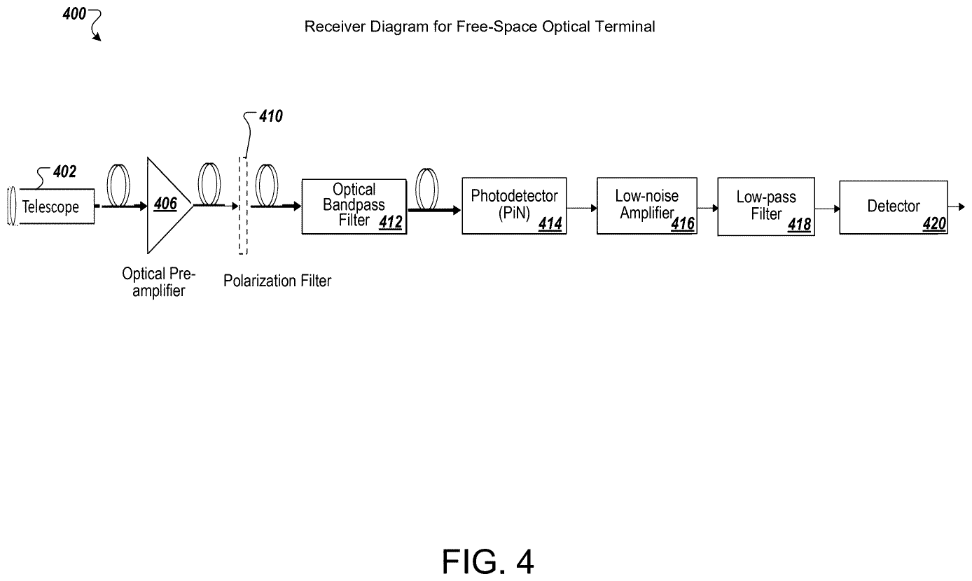

FIG. 4 is a diagram showing an example of a receiver 400 for a free-space optical terminal for a satellite 110. The example of FIG. 4 shows the receiver portion of a LCT, where the receiver 400 utilizes direct detection and an optical pre-amplifier 406.

The receiver includes a telescope 402 having lens system that focuses a portion of the incident optical signal to the optical-fiber-coupled optical pre-amplifier 406. When using direct detection, the receiver performance is primarily a function of the received optical power. A polarization filter 410 at the output of the pre-amplifier 406 helps limit spurious radiation (noise) generated by the pre-amplifier 406 to the polarization of the communication signal. An optical bandpass filter 412 helps limit background radiation and noise generated. After bandpass filtering, the optical signal is incident on a photodetector 414 (e.g., a PiN photodetector having a P-type layer, an Intrinsic (undoped) layer, and an N-type layer) which converts the optical signal to an electrical current.

After low-noise amplification, the electrical signal is processed by a detector 420, such as a conventional detector or slicer, to estimate the transmitted bits (e.g., make bit-hard decisions). The cumulative noise term at the input to the detector 420 is a result of multiple sources such as shot-noise, amplifier spontaneous emission noise, background noise and thermal noise. Further, the received electrical current is also a function of the gain of the low-noise amplifier 416 and pre-amplifier 406 as well as the photodetector 414 responsivity.

As the optical beam emerges from the transmitter telescope (see FIG. 3) and travels through space, the signal will experience diffraction which can be parameterized by the beam divergence angle θ or equivalently by the beam-radius at the transmitter w_0, such that:

$$θ = \frac{λ}{π {w}_{0}}$$

It is possible to relate w₀ to the diameter of the transmitter aperture D(Tx),

$$D ( T x ) = 2 \sqrt{2} \cdot {w}_{0}$$

As the optical beam propagates from the transmitter to the receiver its radius will increase, i.e., diffraction, such that its radius at distance Z is,

$${w}_{z} = {w}_{0} \sqrt{1 + {( \frac{λ Z}{π {w}_{0}^{2}} )}^{2}} \approx Z θ$$

From this, it can be inferred that the beam footprint at some distance Z is directly proportional to the divergence angle θ and inversely proportional to w₀ and the transmitter aperture size D(Tx).

In a direct-detection receiver, the performance depends on the amount optical power that can be focused into the fiber-coupled amplifier 406. The intensity (i.e., power per unit area) of the optical beam is well modelled by a Gaussian intensity profile and in Watts/m² is given by,

$$I = \frac{2}{π {w}_{z}^{2}} \cdot exp ( - 2 \frac{{r}^{2}}{{w}_{z}^{2}} )$$

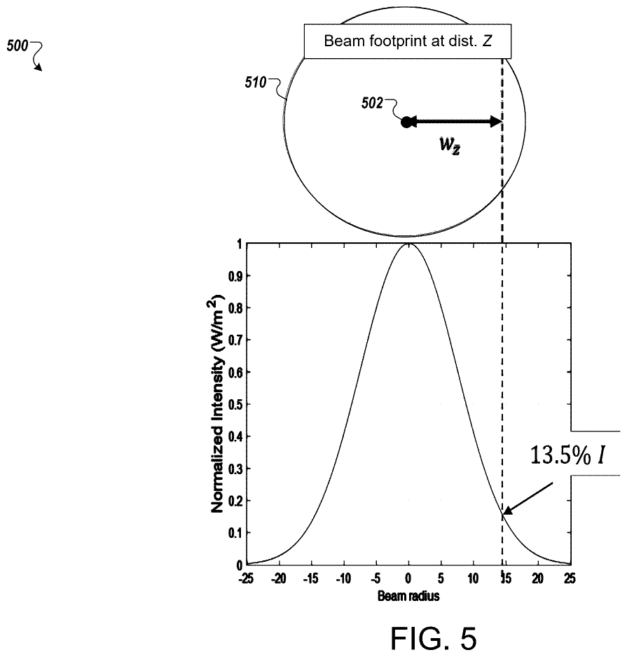

FIG. 5 is a diagram showing an example of free-space optical beam footprint 510 and normalized intensity. Assuming the transmitter 300 and receiver 400 are Z meters apart, the beam radius will increase from w₀ meters at the transmitter to w_{Z} meters at the receiver's telescope 402. The beam footprint 510 at the receiver 400 can be visualized as shown in FIG. 5. The intensity is maximum at the center 502 of the beam. For example, when the radius r is 0 and decreases with increasing radial distance, such that it drops to 13.5% of its maximum value at w_{Z} (beam radius w_{Z} is nominally defined as the distance from the center 502 of the beam where the intensity drops to 13.5% of its maximum value).

If the receiver telescope 402 has an aperture of diameter D(Rx), its radius is simply a(Rx)=0.5D(Rx). The optical power coupled to the optical detector (i.e., input of the pre-amplifier) can be found by integrating the intensity over area of the receiver aperture (π·a(Rx)²). Equivalently, the Friis equation can also be applied to calculate the received optical power, such that,

$${P}_{r} ∼ {P}_{t} \frac{8}{{θ}^{2}} \cdot {( \frac{λ}{4 π Z} )}^{2} \cdot {( \frac{2 π a ( R x )}{λ} )}^{2}$$

where Pₜ is the optical power (e.g., in Watts) emitted from the transmitter telescope 312.

The following examples illustrate the link calculations for an FSO system in space:

Example 1: Consider λ=1550 nm, D(Rx)=8 cm, D(Tx)=8 cm, Z=5400 km. Hence, the beam divergence is θ=17.4 μrad, the beam waist at the transmitter is w₀=2.8 cm, and the beam radius at 5400 km is w_{Z}=94.2 m. The received optical power in dB is,

$${P}_{r} ( dB ) = {P}_{t} ( dB ) - 64.4 dB .$$

Example 2: Similarly, when λ=1550 nm, D(Rx)=16 cm, D(Tx)=8 cm, Z=5400 km. Hence, the beam divergence is θ=17.4 μrad, the beam waist at the transmitter is w₀=2.8 cm, and the beam radius at 5400 km is w_{Z}=94.2 m. The received optical power in dB is,

$${P}_{r} ( dB ) = {P}_{t} ( dB ) - 58 dB .$$

Example 3: When λ=1550 nm, D(Rx)=8 cm, D(Tx)=16 cm, Z=5400 km. Hence, the beam divergence is θ=8.7 μrad, the beam waist at the transmitter is w₀=5.6 cm, and the beam radius at 5400 km is w_{Z}=47.1 m. The received optical power in dB is, E

$${P}_{r} ( dB ) = {P}_{t} ( dB ) - 58 dB .$$

Example 4: When λ=1550 nm, D(Rx)=8 cm, D(Tx)=4 cm, Z=5400 km. Hence, the beam divergence is θ=34.9 μrad, the beam waist at the transmitter is w₀=1.4 cm, and the beam radius at 5400 km is w_{Z}=188.4 m. The received optical power in dB is,

$${P}_{r} ( dB ) = {P}_{t} ( dB ) - 70.5 dB .$$

These examples demonstrate several significant principles regarding free-space optical communication links. For example, increasing the receiver aperture diameter couples more optical power into the optical receiver. In addition, increasing the transmitter aperture diameter makes the beam less divergent and projects more optical power into the receiver's plane. Increasing the divergence angle θ results in a larger beam footprint at the receiver. However, increasing the aperture diameter has an adverse impact by increasing cost, size, and weight of the optical terminals and makes it more challenging to maintain a stable line-of-sight. As a result, the communication parameters are often chosen after careful consideration or optimization.

The example calculations above assumed that the center of the transmitted beam is perfectly aligned with the center of the receiver's aperture. Since the intensity of the beam is maximum at its center, such an alignment allows for maximum possible power to be coupled into the receiver. However, that is not achieved for many communication links, especially due to pointing jitter.

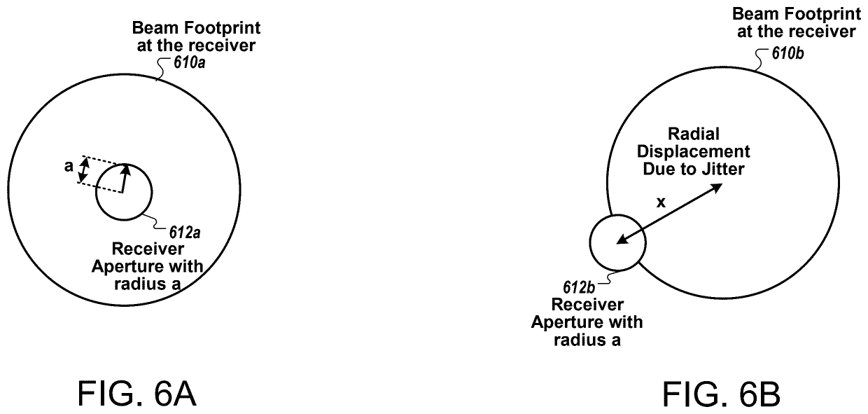

FIGS. 6A-6B are diagrams showing examples of transmitted beam footprints and position of a receiver's aperture. In particular, the figures show the beam footprint 610a, 610b at the receiver's plane and the receiver aperture 612a, 612b. FIG. 6A depicts a scenario with perfect pointing, and FIG. 6B depicts a scenario with a pointing error due to jitters.

FIG. 6A depicts an ideal scenario in which the center of the transmitted beam 610a is aligned perfectly with the center of the receiver aperture 612a. However, as mentioned previously, the closed loop tracking and pointing mechanism is subject to errors from various factors. These errors cause random displacements between the beam and the receiver aperture as shown in FIG. 6B, where the receiver aperture 612b has shifted to the outer edge of the beam footprint 610a and misses the central, highest-energy portion of the beam. Due to this displacement, less power will be coupled from the beam into the optical receiver. The random displacements are known as pointing jitters.

The power loss due to pointing jitter is a function of the radial distance between the two centers dₚ which is modelled as a Rayleigh distributed random variable

$$f ( {d}_{p} ) = \frac{{d}_{p}}{{σ}_{s}^{2}} {e}^{( \frac{- {d}_{p}^{2}}{2 {σ}_{s}^{2}} )}$$

The parameter σₛ is the Rayleigh scale parameter and is related to the angular pointing jitter standard deviation as follows,

$${σ}_{s} = {σ}_{p} \cdot Z$$

The parameter σₚ is generally in order of a few micro-radians. Large values of σₚ result in larger dₚ and hence more power loss. The loss in received optical power degrades the error rate performance of the communication link.

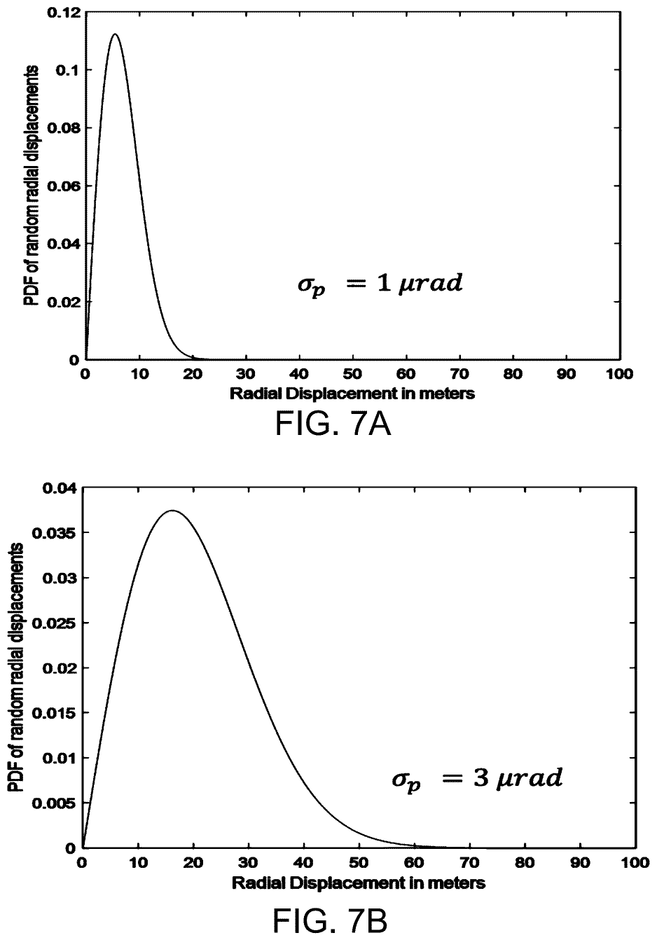

FIGS. 7A-7B are graphs showing probability density functions (PDFs) of random radial displacement due to pointing jitters, in particular, when σₚ=1 rad (FIG. 7A), and σₚ=3 μrad (FIG. 7B). As expected, larger angular jitter can result in larger radial displacements. In other words, a larger value of σₚ can result in more power loss at the receiver due to larger displacements between the beam and the receiver's aperture.

As an example, revisiting Example 1 above in which λ=1550 nm, D(Rx)=8 cm, D(Tx)=8 cm, Z=5400 km. If σₚ=3 μrad and dₚ=20.3 m (mean value), the received optical power in dB is:

$${P}_{r} ( dB ) = {P}_{t} ( dB ) - 64.8 dB$$

As a result, a 0.5 dB loss in received power is seen in the example. Since this displacement is random, the received power will fluctuate below the nominal value and adversely affect the error rate performance.

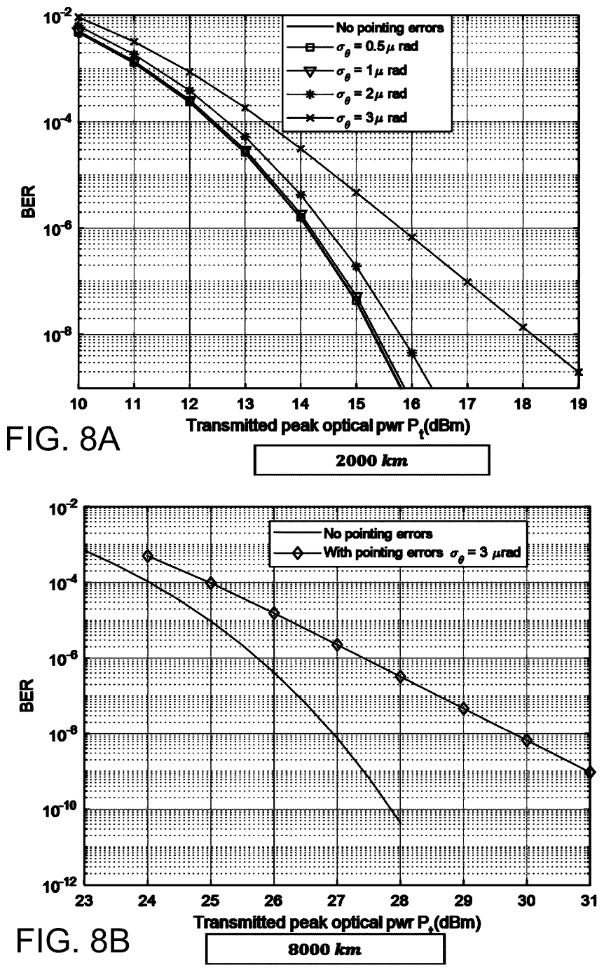

FIGS. 8A-8B are graphs showing bit error rates of an optical inter-satellite link using intensity modulation with direct detection, with and without pointing errors. Bit error rate performance is evaluated for the baseline FSO system depicted in FIGS. 3 and 4, with and without pointing errors using Monte-Carlo simulations. The error rate is plotted versus the transmitted optical power, measured at the transmitter aperture output. Results are shown for two different path length, Z=2000 km (FIG. 8A) and Z=8000 km (FIG. 8B). Additionally, we assume λ=1550 nm, D(Rx)=8 cm, D(Tx)=8 cm, and a data rate of 5 Gbps. For due diligence, noise sources, including amplifier spontaneous emission noise, shot noise, background noise, etc., are modelled in the simulation. Due to very high data rate optical ISLs have a very low bit error rate requirement in the order of 10⁻⁸ to 10⁻⁹. Additionally, due to power limitations in the satellite, it is desirable to achieve the target BER using the least amount of transmit power. The results reveal a noticeable performance degradation when σₚ>1 μrad. Furthermore, the degradation under strong pointing errors seems independent of the path length.

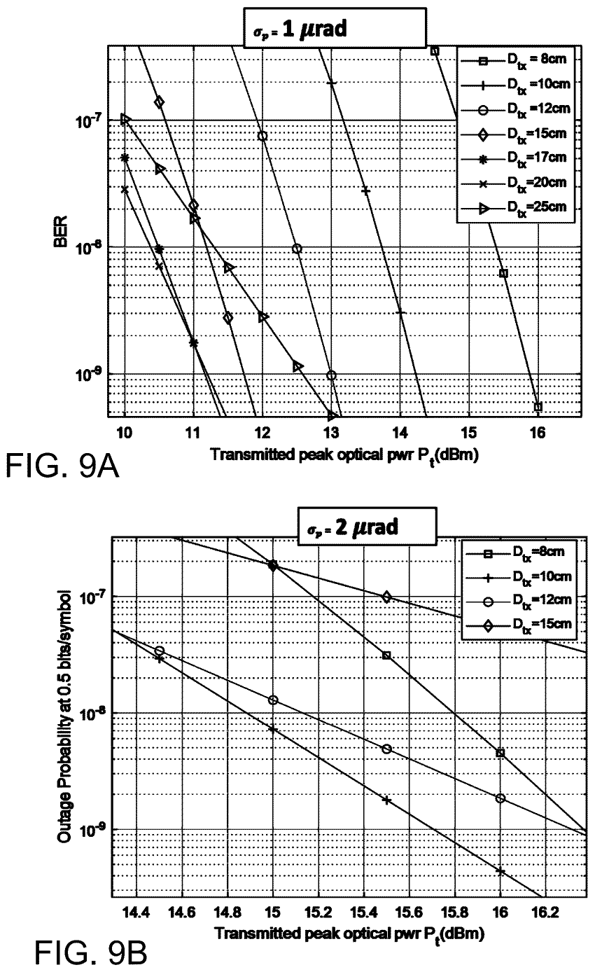

FIG. 9A is a graph showing a bit error rate based on optimizing beam divergence angle or transmitter aperture diameter. FIG. 9B is a graph showing an outage probability measure based on optimizing beam divergence angle or transmitter aperture diameter. One solution to improve link performance under strong jitters is to improve the mechanical, electrical, and optical components in the tracking loop, for instance by utilizing a more expensive photodetector for the tracking loop. Another technique is to adjust the beam divergence angle at the transmitter, for instance by increasing or decreasing the diameter of the transmitter aperture. This is illustrated in FIG. 9A when the path length is 2000 km, data rate is 5 Gbps and for σₚ=1 μrad. At the target BER of 10⁻⁹ the optimum diameter of the transmitter aperture is ~17 cm, which is more the twice the baseline diameter of 8 cm typically found in commercial optical ISL terminals. FIG. 9B shows the case when σₚ=2 μrad for the same data rate, wavelength, and path length. For this scenario, the optimum diameter is ~10 cm. The results indicate that the optimum diameter is strongly influenced by the amount of pointing jitter, which is not known a priori. Additionally, larger apertures are generally more expensive.

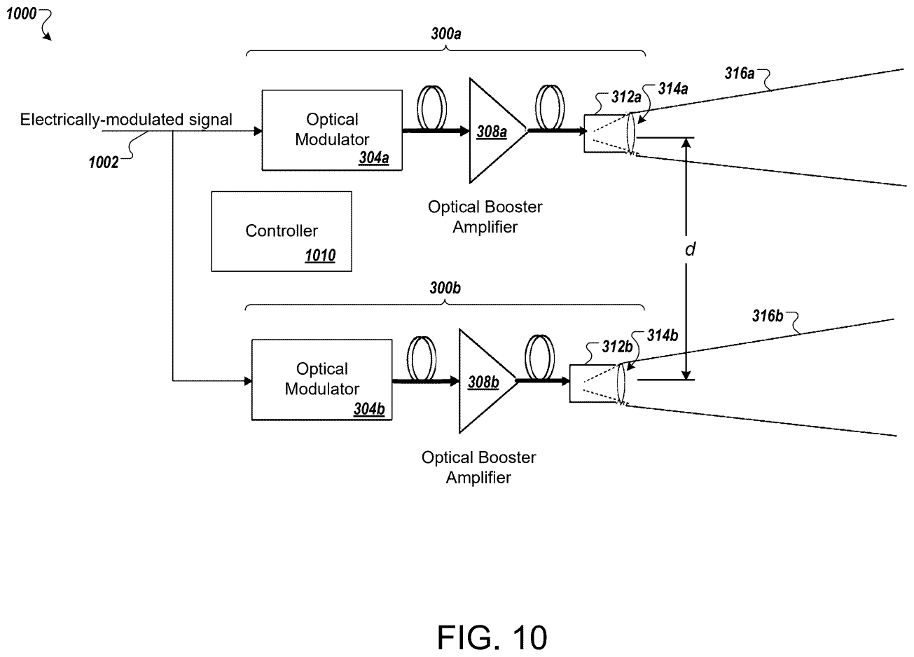

FIG. 10 is a diagram of an example of a transmitter 1000 that employs spatial diversity with repetition coding to mitigate the effects of pointing jitter. The transmitter utilizes two optical transmit apertures 314a, 314b, each of which can be the same as the optical transmit aperture of the baseline design. Furthermore, the transmitter 1000 can control the output so that both apertures 314a, 314b simultaneously transmit the same data, e.g., implement repetition coding. To ensure power efficiency, the total transmit power from the two apertures 314a, 314b is the same as the baseline scenario with a single optical transmit aperture, so each of the optical transmit apertures 314a, 314b transmits at half the power a single-aperture transmitter would use.

In the example, the transmitter 1000 obtains two optical transmit apertures by using two transmitters 300 as discussed in FIG. 3, e.g., with a first transmitter 300a and a second transmitter 300b. In this case, both transmitters 300a, 300b receive the same electrically-modulated signal 1002 as input, and each transmitter 300a, 300b has a separate optical modulator 304a, 304b that generates the optical output, e.g., OOK-modulated light pulses. The two transmitters 300a, 300b, or at least their telescopes 312a, 312b, are located on the same side or facing outward from a same side of a satellite 110. This way, the optical transmit apertures 314a, 314b can both be concurrently pointed toward the same receiving satellite, and both transmitters 300a, 300b can be used together to provide an ISL 120.

The operation of the optical modulators 304a, 304b can be coordinated and synchronized by a controller 1010 that manages operation of the transmitter 1000. The controller 1010 can also include control loops for acquisition, pointing, and tracking, as well as send the control signals to gimbals and other components that position or stabilize the telescopes 312a, 312b. Typically, the controller 1010 includes a feedback loop that uses information from the receiving satellite 100 about the received power or other signal quality measures to adjust the position of the telescopes 312a, 312b. In some implementations, the controller 1010 includes a separate control loop for each telescope 312a, 312b, so the gimbal or other positioning equipment for each telescope 312a, 312b operates independently. In some implementations, the controller 1010 uses a single control loop to position the gimbals for the telescopes 312a, 312b together.

Even with the feedback control loop(s) operating properly, there will typically still be jitter that reduces performance, but which the dual transmission can mitigate. ISLs 120 often operate at a high data rate, so even a very short sudden angular shift can result in the loss of many bits.

Although two full transmitters 300a, 300b are shown in the example, other implementations are possible. For example, in some implementations, a single optical modulator can be used, and an optical signal can be split or duplicated to be output in a synchronized manner by two or more optical transmit apertures 312a, 312b.

The two optical transmit apertures can be used to transmit to a single receiver aperture (e.g., with both optical transmit apertures 312a, 312b pointing to the single receiver aperture of another satellite 110) or to two receiver apertures (e.g., with the optical transmit apertures 312a, 312b pointed to different receiver apertures of the same satellite 110 as part of a single ISL 120).

In the example, of FIG. 10, the common information signal 1002 representing data to be transmitted is processed by two independent optical modulators 304a, 304b and converted to optical signals. The optical signals are fiber-coupled to their respective booster amplifiers 308a, 308b and telescopes 312a, 312b. The two optical transmit apertures 314a, 314b are separated by a distance d meters, which is a known predetermined value in the system. The separation distance, d, can vary depending on the application and the size of the satellite, such as 10 cm, 20, cm, 30, cm, 40, cm, etc.

Different scenarios are examined to quantify the advantages of this scheme. For the example scenarios discussed to demonstrate the technique, we assume λ=1550 nm, data rate 5 Gbps and Z=8000 km. In the example, the diameter of each optical transmit aperture 314a, 314b is 8 cm. The optical receive aperture of the receiver can also be 8 cm.

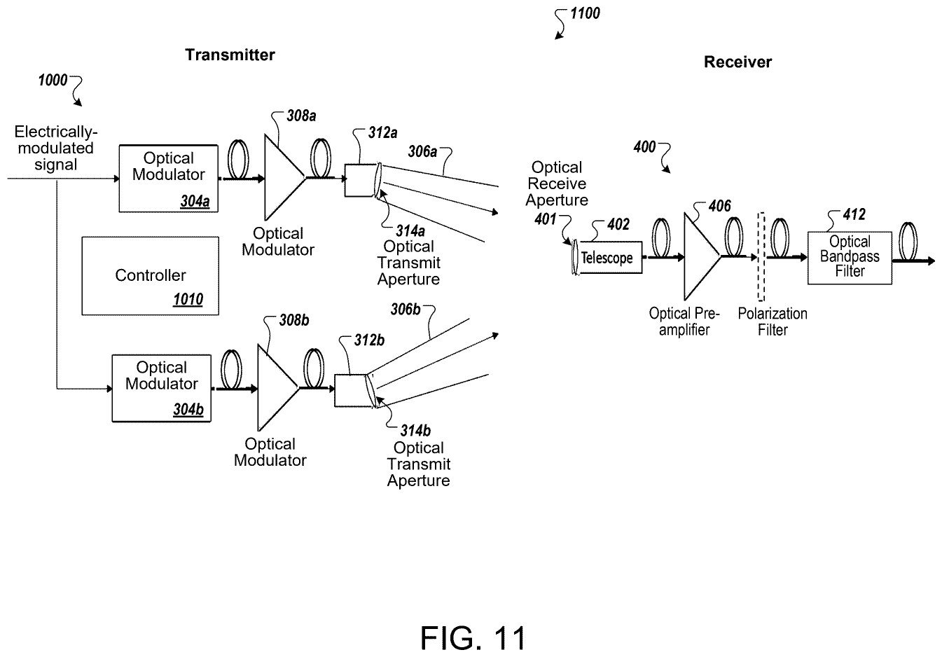

FIG. 11 is a diagram of the transmitter 1000 of FIG. 10, positioned in alignment with a receiver 400 such as shown in FIG. 4. In this first example, the two transmit apertures 314a, 314b are pointed toward the center of a single receiver aperture 401. In the example, the apertures 314a, 314b of the two optical transmitters 300a, 300b have been aligned after acquisition and pointing to the center of the receiver aperture 401 as shown in FIG. 11. In many cases, the gimbals for the telescopes 312a, 312b are controlled so each optical transmit aperture 314a, 314b is pointed as closely as possible to the center of the optical receive aperture 401, but the system is tolerant to some boresight error. The transmitter 1000 is configured so that there is overlap of the beams transmitted by the apertures 314a, 314b at the optical receive aperture 401. Typically the amount of overlap of the beams is maintained consistent during the use of an ISL 120.

Even after the initial alignment of the transmit apertures 314a, 314b and the receive aperture 401, jitter may cause random movement. For example, some movements of the optical transmit apertures 314a, 314b may be independent of each other, while other movements may be correlated or shared by the transmit apertures 314a, 314b. The use of two transmit apertures 314a, 314b mitigates jitter in several ways. For example, for non-correlated movement of the optical transmit apertures 314a, 314b, if jitter shifts one optical transmit aperture temporarily, the receiver 400 is still likely to receive transmitted signals from the other optical transmit aperture. For correlated movements, even if the optical transmit apertures 314a, 314b move together, the beams combine to together provide a somewhat larger beam area at the receive aperture 401, making it more likely the receiver 400 can continued detection during the jitter.

Because the two transmitters 300a, 300b are sending the same data at the same time, the receiver 400 can add the power received from both to detect the transmitted signals. This is a non-coherent system, in the sense that there is no need to recover the phase of the transmitted signals, because all of the information is carried in the amplitude of the signals. As a result, the receiver 400 can add the power it receives from the beams of both transmitters 300a, 300b.

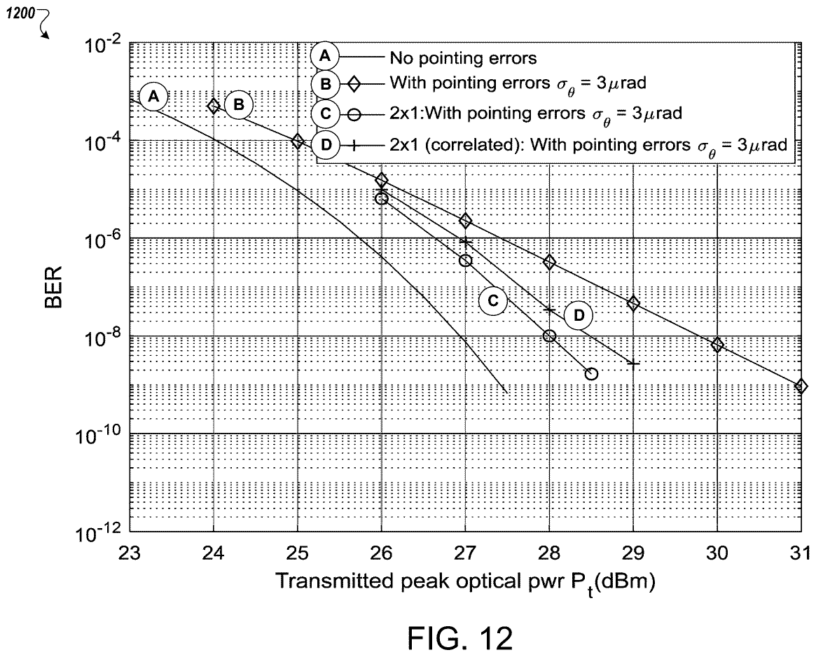

FIG. 12 is a graph showing bit error rates for different conditions, including a condition in which two transmitters are aligned with a single receiver, which shows improvement resulting from spatial diversity with repetition coding. FIG. 12 shows error rate performance of spatial diversity with repetition scheme under very strong pointing jitter parameterized by σₚ=3 μrad. The error rate is plotted versus the transmitted optical power, measured at the optical transmit aperture outputs.

In the chart, lower on the vertical axis indicates lower error rate. For a given position on the horizontal axis representing a power level, the best-performing curve is the one that is lowest along the vertical axis at that horizontal position. Curve A shows an ideal case where no pointing errors occur, and so maximum performance (e.g., minimum amount of errors) is achieved. Curve B shows an example of a system employing a single optical transmit aperture and single receiver, which suffers more than 3 dB loss relative to the ideal case with perfect pointing shown in Curve B.

Curve C shows the result of using two optical transmit apertures and splitting the total transmitted power equally among them. This technique provides close to 2.5 dB improvement in performance over the single-transmit-aperture example (Curve B). Although the magnitude of jitter is the same for both examples, the jitter has somewhat different effects. For Curve B, the jitter always affects the entire amount of transmitted power, which increase the error rate compared to Curve A. For the case of Curve C, when jitter affects one optical transmit aperture 314a, the other optical transmit aperture 314b is not affected and continues to provide a more accurate source of signal to the receiver. The error rate is increased compared to Curve A, but less so than for Curve B.

Curve D shows the case in which the displacements experienced by the two beams in the receiver plane are correlated. This models the phenomenon that the pointing jitters are partially caused by vibrations in the transmitting satellite 110. Despite the correlation, spatial diversity still provides a 2 dB gain over the baseline system with no transmitter diversity (Curve B). It is noteworthy that this technique improves the slope of the error rate curve, which is a desirable phenomenon in mitigating signal outages caused by random pointing jitters. In other words, with spatial diversity, increases in transmitted power improve the error rate more quickly than in the baseline system, which shows an improvement in power efficiency to achieve various error rate targets.

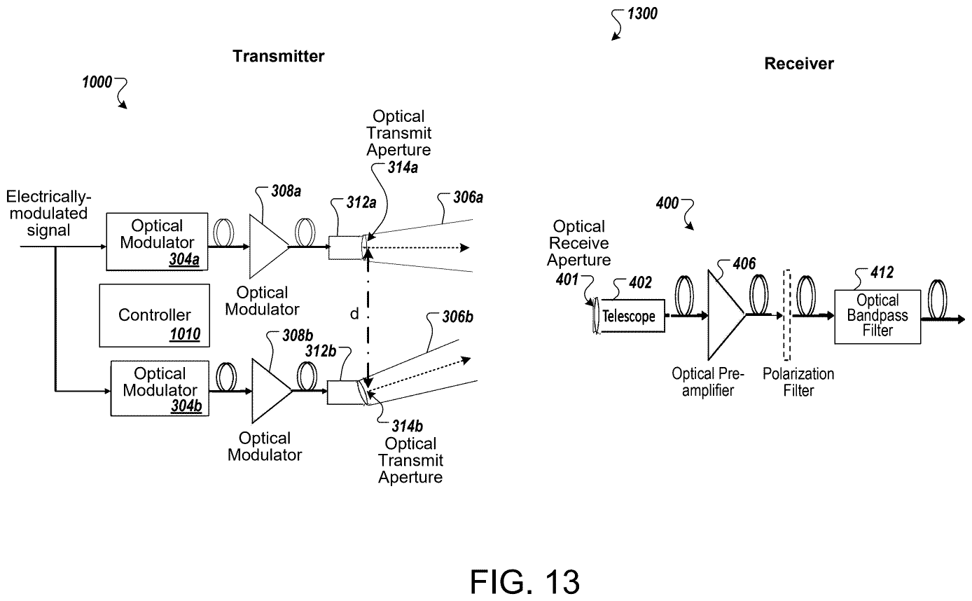

FIG. 13 is a diagram showing an example depicting use of spatial diversity when two transmitters are not jointly aligned with the single receiver's boresight. In this case, the two transmit apertures are not ideally aligned to the center of the receiver's aperture. For example, one telescope 312b is substantially aligned with the optical receive aperture 401, but the other telescope 312a is not. Alternatively, another scenario is when the transmitters 300a, 300b are pointed to their respective boresights, as is the receiver 400, but the boresights are generally in the field-of-view of the receiver 400, which is a reasonable assumption after open loop acquisition is completed and a closed-loop tracking has been activated.

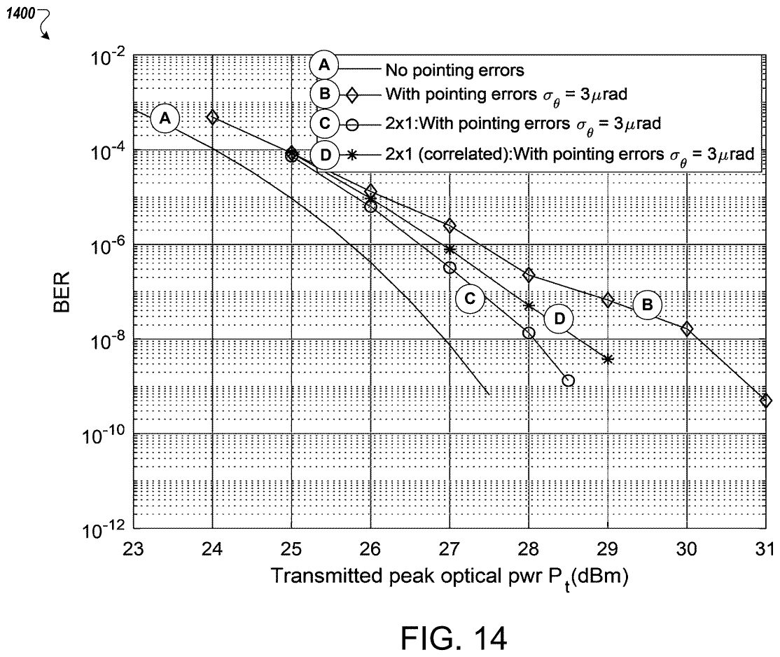

FIG. 14 is a graph showing bit error rates for different conditions, including a condition in which two transmitters are not jointly aligned with a single receiver, which shows improved performance resulting from spatial diversity with repetition coding even though the two transmitters are not ideally aligned with the receiver and are under strong jitters. In the example, the centers of two transmit apertures 314a, 314b are 30 cm apart.

Curve A shows an example with no pointing errors, and thus shows the minimum error rates possible for the scenario. Curve B shows the results with a single transmitter and a single receiver, with pointing error and with pointing jitter. Curve C shows the result of two transmitters pointing toward a single receiver, where one of the transmitters has pointing error (see FIG. 13), and both experience pointing jitter that is uncorrelated. Curve D shows the result of two transmitters pointing toward a single receiver, with pointing errors and jitter, but where the jitter for the transmitters is correlated. FIG. 14 shows that using two transmitters in curve C provides close to 2.5 dB improvement over the baseline case of Curve B, even for the same total transmitted power, despite the two transmitters boresight being offset somewhat from the receiver's line-of-sight. The performance gain is comparable to the previous case when the apertures were ideally aligned before data transfer (FIGS. 11-12). This indicates that the use of multiple transmit apertures with repetition coding can help alleviate very stringent line-of-sight requirements between the transmit and receive terminals.

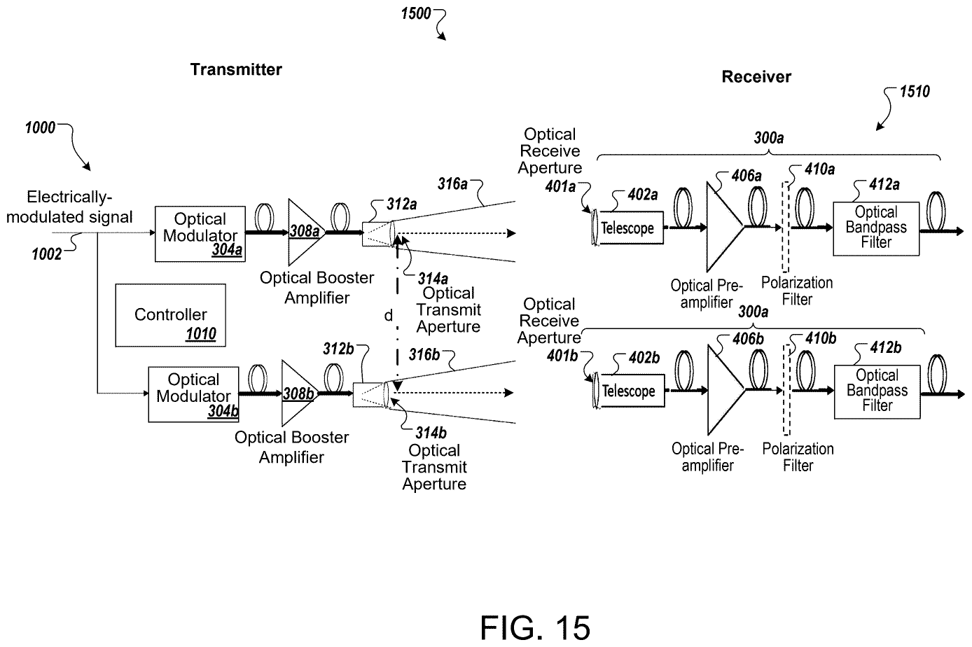

FIG. 15 is a diagram showing an example depicting the use of spatial diversity with repetition coding, using two optical transmit apertures 314a, 314b aligned with two optical apertures 401a, 401b at the receiving satellite 110. In the example, two optical transmit apertures 314a, 314b are pointed to the centers of two optical receive apertures 401a, 401b. The two optical receive apertures 401a, 401b both collect transmitted power for the same ISL 120. Ideally, each optical transmit aperture 314a, 314b is pointed to its corresponding receive aperture 401a, 401b, which can maximize the amount of transmitted power from each optical transmit aperture 314a, 314b to the corresponding receive aperture 401a, 401b. Repetition coding is employed for the transmission.

In some implementations, the receiving satellite 100 has two receivers 400 as shown in FIG. 4. In other implementations, the two receivers may share some components, so not all of the components in FIG. 4 are replicated. For example, the light from two receive apertures 401a, 401b can be combined, before or after amplification and filtering, and then the combined light is provided to a single photodetector 414, low-noise amplifier 416, low-pass filter 418, and detector 420. In some implementations, even the pre-amplifier 406, polarization filter 410, and/or optical bandpass filter 412 are shared or used on combined light of multiple receive apertures 401a, 401b. Nevertheless, the example of FIG. 15 shows that each optical receive aperture 401a, 401b can have its own separate optical path (e.g., including a telescope 402a, 402b, an optical pre-amplifier 406a, 406b, a polarization filter 410a, 410b, and an optical bandpass filter 412a, 412b) at least up to the photodetector 414. Optical signals from the two paths can be combined at a single photodetector 414, or after conversion to electrical signals with separate photodetectors 414 the electrical signals can be combined for processing by a single detector 420.

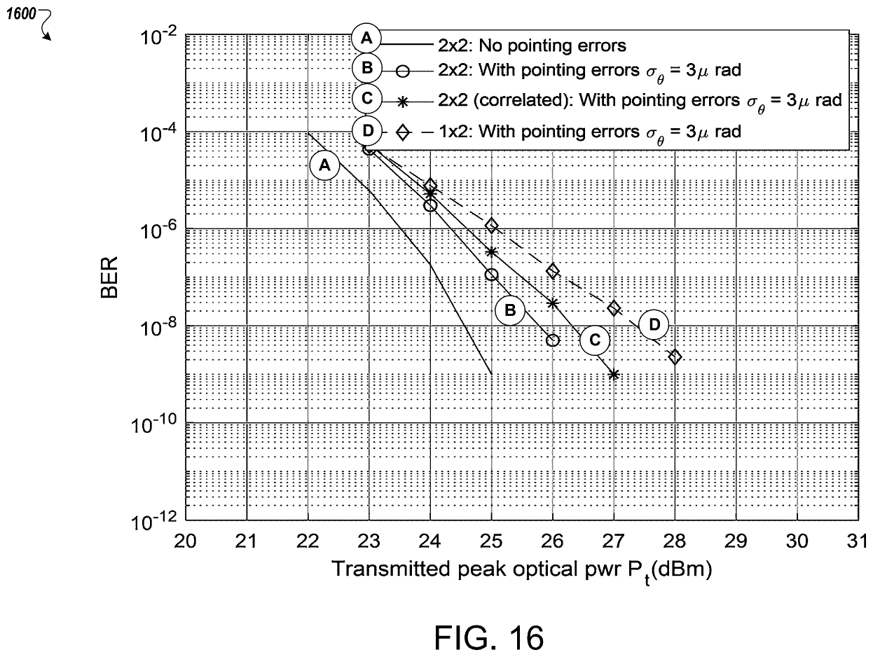

FIG. 16 is a graph showing bit error rates for different conditions, including a condition in which two transmitters are aligned to separate optical apertures of a receiving satellite. The graph shows increased resilience to strong pointing errors and also an additional power gain due the use of two receiver apertures 401a, 401b.

In the graph, Curve A shows a case with two transmit apertures and two receive apertures (“2×2”) without any pointing jitter. Curve B shows a case with two transmit apertures and two receive apertures (“2×2”), but with pointing jitter. Curve C shows a case with two transmit apertures and two receive apertures (“2×2”), but with correlated pointing jitter. Curve D shows a case with one transmit aperture and two receive apertures (“1×2”) with pointing jitter. The examples reveal a performance improvement from two factors. The first factor is a power gain relative to a system that utilizes a single receiver aperture. This is because the two receiver apertures each have the same diameter (e.g., 8 cm) as a single aperture, and so the total area for receiving incident light is doubled when two receive apertures are used. The second factor is an improvement in the slope of the error rate curve, which indicates resilience to pointing jitter. In other words, Curves B and C show a steeper slope than the curve D, showing that using two transmit apertures results in a higher power efficiency than a single transmit aperture, even when two optical receive apertures are used.

A number of variations to the designs can be made. For example, more than two transmitters 300 or more than two receivers 400 can be used. In some cases, three, four, or more transmitters 300 or optical transmit apertures 314 can be used. Similarly, three, four, or more receivers 400 or optical receive apertures 401 can be used.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the invention have been described. Other embodiments are within the scope of the following claims. For example, the steps recited in the claims can be performed in a different order and still achieve desirable results.

1. A satellite comprising:
a communication terminal configured to establish an inter-satellite data transfer link with a second satellite, wherein the communication terminal comprises multiple optical transmit apertures and is configured to use the multiple optical transmit apertures together to establish the inter-satellite data transfer link with the second satellite,
wherein each of the optical transmit apertures of the multiple optical transmitters are each positionable;
wherein the communication terminal is configured to cause the multiple optical transmitters to perform synchronized transmission of a same data stream; and
wherein the communication terminal comprises a controller that is configured to adjust positions of the optical transmit apertures based on indications of received signal quality from the second satellite.

2. The satellite of claim 1, wherein the communication terminal of the satellite is configured to separately position the optical transmit apertures.

3. The satellite of claim 1, wherein the communication terminal of the satellite is configured to adjust a position of the optical transmit apertures to selectively transmit to (i) a single receive aperture of the second satellite or (ii) multiple receive apertures of the second satellite.

4. The satellite of claim 1, wherein the communication terminal of the satellite is configured to operate in multiple modes, including (i) a first mode in which the multiple optical transmit apertures are directed to a same, single receive aperture of the second satellite, and (ii) a second mode in which the multiple optical transmit apertures are directed to separate receiver apertures of the second satellite.

5. The satellite of claim 1, wherein the controller of the communication terminal is configured to position the optical transmit apertures to (i) align the optical transmit apertures with one or more optical receive apertures of the second satellite and (ii) maintain alignment of the optical transmit apertures with one or more optical receive apertures of the second satellite over time.

6. The satellite of claim 1, comprising a separate optical modulator for each of the optical transmit apertures; and
wherein the communication terminal is configured to receive an electrical information signal and to provide the received electrical information signal to the optical modulators, such that each of the optical modulators separately converts the electrical information signal to optical signals.

7. The satellite of claim 6, comprising a separate optical booster amplifier and telescope for each of the optical transmit apertures, and wherein each of the optical modulators is coupled to its corresponding optical booster amplifier and telescope through fiber optics.

8. A method performed by one or more processors, the method comprising:
initiating, by a first satellite, a inter-satellite data transfer link with a second satellite, wherein the first satellite comprises multiple optical transmit apertures configured to be used concurrently to provide the inter-satellite data transfer link;
positioning, by the first satellite, the optical transmit apertures with respect to the second satellite;
performing, by the first satellite, synchronized transmission of a same data stream using each of the multiple optical transmit apertures; and
adjusting, by the first satellite, positions of the optical transmit apertures based on indications of received signal quality from the second satellite.

9. The method of claim 8, wherein positioning the optical transmit apertures comprises separately positioning the optical transmit apertures.

10. The method of claim 8, wherein the first satellite is configured to adjust a position of the optical transmit apertures to selectively transmit (i) from multiple optical transmit apertures to a same single receive aperture of the second satellite or (ii) from multiple optical transmit apertures to different corresponding receive apertures of the second satellite.

11. The method of claim 8, wherein the first satellite is configured to operate in multiple modes, including (i) a first mode in which the multiple optical transmit apertures are directed to a same, single receive aperture of the second satellite, and (ii) a second mode in which the multiple optical transmit apertures are directed to separate receiver apertures of the second satellite.

12. The method of claim 8, comprising:
aligning the optical transmit apertures with one or more optical receive apertures of the second satellite; and
adjusting positions of the optical transmit apertures to maintain alignment of the optical transmit apertures with one or more optical receive apertures of the second satellite over time.

13. The method of claim 8, wherein the first satellite comprises a separate optical modulator for each of the optical transmit apertures; and
wherein the method comprises receiving an electrical information signal; and
providing the received electrical information signal to the optical modulators, such that each of the optical modulators separately converts the electrical information signal to optical signals.

14. The method of claim 13, wherein the first satellite comprises an optical booster amplifier and telescope for each of the optical transmit apertures, and wherein each of the optical modulators is coupled to its corresponding optical booster amplifier and telescope through fiber optics.

15. One or more non-transitory machine-readable media storing instructions that are operable, when executed by one or more processors of a first satellite, to cause the first satellite to perform operations comprising:
initiating, by the first satellite, a inter-satellite data transfer link with a second satellite, wherein the first satellite comprises multiple optical transmit apertures;
positioning, by the first satellite, the optical transmit apertures with respect to the second satellite;
performing, by the first satellite, synchronized transmission of a same data stream using each of the multiple optical transmit apertures; and
adjusting, by the first satellite, positions of the optical transmit apertures based on indications of received signal quality from the second satellite.

16. The one or more non-transitory machine-readable media of claim 15, wherein positioning the optical transmit apertures comprises separately positioning the optical transmit apertures.

17. The one or more non-transitory machine-readable media of claim 15, wherein the first satellite is configured to adjust a position of the optical transmit apertures to selectively transmit (i) from multiple optical transmit apertures to a same single receive aperture of the second satellite or (ii) from multiple optical transmit apertures to different corresponding receive apertures of the second satellite.

18. The one or more non-transitory machine-readable media of claim 15, wherein the first satellite is configured to operate in multiple modes, including (i) a first mode in which the multiple optical transmit apertures are directed to a same, single receive aperture of the second satellite, and (ii) a second mode in which the multiple optical transmit apertures are directed to separate receiver apertures of the second satellite.

19. The one or more non-transitory machine-readable media of claim 15, comprising:
aligning the optical transmit apertures with one or more optical receive apertures of the second satellite; and
adjusting positions of the optical transmit apertures to maintain alignment of the optical transmit apertures with one or more optical receive apertures of the second satellite over time.

20. The one or more non-transitory machine-readable media of claim 15, wherein the first satellite has an independent optical modulator for each of the optical transmit apertures; and
wherein the method comprises receiving an electrical information signal; and
providing the received electrical information signal to the optical modulators, such that each of the optical modulators independently converts the electrical information signal to optical signals.
